(19) United States
(12) Patent Application Publication
(10) Pub. No.: US 2014/0346257 A1
(43) Pub. Date: Nov. 27, 2014

(54) Spray Tool Locking System

(71) Applicant: Finishing Brands Holdings Inc., Minneapolis, MN (US)

(72) Inventors: Eric F. Reetz, III, Broomfield, CO (US); Joel Alan Reetz, Denver, CO (US)

(73) Assignee: Finishing Brands Holdings Inc., Minneapolis, MN (US)

(21) Appl. No.: 14/265,137

(22) Filed: Apr. 29, 2014

Related U.S. Application Data
(60) Provisional application No. 61/826,936, filed on May 23, 2013.

(51) Int. Cl. B05B 12/00

(52) U.S. Cl. CPC B05B 12/002
USPC 239/526

(57) ABSTRACT

A system including a sprayer including a handle, a trigger configured to move between a first trigger position and a second trigger position, wherein the sprayer is configured to block flow of a coating material when the trigger is in the first trigger position and to spray the coating material when the trigger is in the second trigger position, a trigger lock coupled to the trigger, wherein the trigger lock is configured to selectively block movement of the trigger between the first trigger position and the second trigger position.

### CROSS-REFERENCE TO RELATED APPLICATION

This Application is a Non-Provisional Application and claims priority to US Provisional Patent Application No. 61/826,936, entitled “Spray Tool Locking System”, filed May 23, 2013, which is herein incorporated by reference.

### BACKGROUND

The invention relates generally to a spray tool locking system.

Spray tools output sprays to more efficiently coat objects. For example, spray tools may be used to paint objects or otherwise coat target objects with a coating material. Spray tools typically include a trigger that enables a user to selectively spray a coating material from the spray tool. Unfortunately, spray tools may allow a user to unintentionally depress the trigger and waste coating material.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment a system including a sprayer including a handle, a trigger configured to move between a first trigger position and a second trigger position, wherein the sprayer is configured to block flow of a coating material when the trigger is in the first trigger position and to spray the coating material when the trigger is in the second trigger position, a trigger lock coupled to the trigger, wherein the trigger lock is configured to selectively block movement of the trigger between the first trigger position and the second trigger position.

In another embodiment, a system including a magnetic trigger lock configured to block movement of a trigger of a sprayer between a first trigger position and a second trigger position, wherein the first trigger position does not actuate a mechanism coupled to the trigger, and the second trigger position does actuate the mechanism.

In another embodiment a system including a valve of a sprayer, a trigger coupled to the valve, wherein the trigger is configured to move between a first trigger position and a second trigger position, the valve is closed when the trigger is in the first trigger position, and the valve is open when the trigger is in the second trigger position, a magnetic trigger lock coupled to the trigger, wherein the magnetic trigger lock is configured to block movement of the trigger between the first trigger position and the second trigger position.

### DRAWINGS

These and other features, aspects, and advantages of the present invention will become better understood when the following detailed description is read with reference to the accompanying drawings in which like characters represent like parts throughout the drawings, wherein:

FIG. 1 is a side view of a spray tool system with a trigger lock according to an embodiment;

FIG. 2 is a partial cross-sectional side view of an embodiment of a spray tool system with a trigger lock in a locked position, taken along line 2-2 of FIG. 1;

FIG. 3 is a partial cross-sectional side view of an embodiment of a spray tool system with a trigger lock in an unlocked position, taken within line 2-2 of FIG. 1;

FIG. 4 is a partial cross-sectional side view of an embodiment of a spray tool system with a trigger lock, taken within line 2-2 of FIG. 1;

FIG. 5 is a partial cross-sectional side view of an embodiment of a spray tool system with a trigger lock, taken within line 2-2 of FIG. 1;

FIG. 6 is a perspective view of a trigger lock according to an embodiment; and

FIG. 7 is a partial cross-sectional side view of an embodiment of a spray tool system with a trigger lock, taken within line 2-2 of FIG. 1.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to a trigger lock capable of blocking unintentional use of a spray tool. The trigger lock may couple to the trigger and/or the handle and transition between a locked and unlocked position that blocks or enables use of a trigger. In some embodiments, the trigger lock may include position holding features (e.g., snap, magnet, latch, etc.) to resist transitioning between the locked and the unlocked positions. For example, the trigger lock may include one or more magnets that resist movement of the trigger lock from the locked position to the unlocked position. In another embodiment, the trigger lock may include a friction device that frictional engages a pin in either the trigger or the handle to resist rotation of the trigger lock. In still another embodiment, the pin may include recesses that increase the rotational resistance of the trigger lock. In other embodiments, the trigger lock or handle may include protrusions or recesses that engage counterpart recesses or protrusions on the trigger lock or handle. The resistance of the trigger lock to movement between the locked and unlocked positions blocks unintentional depression of the trigger.

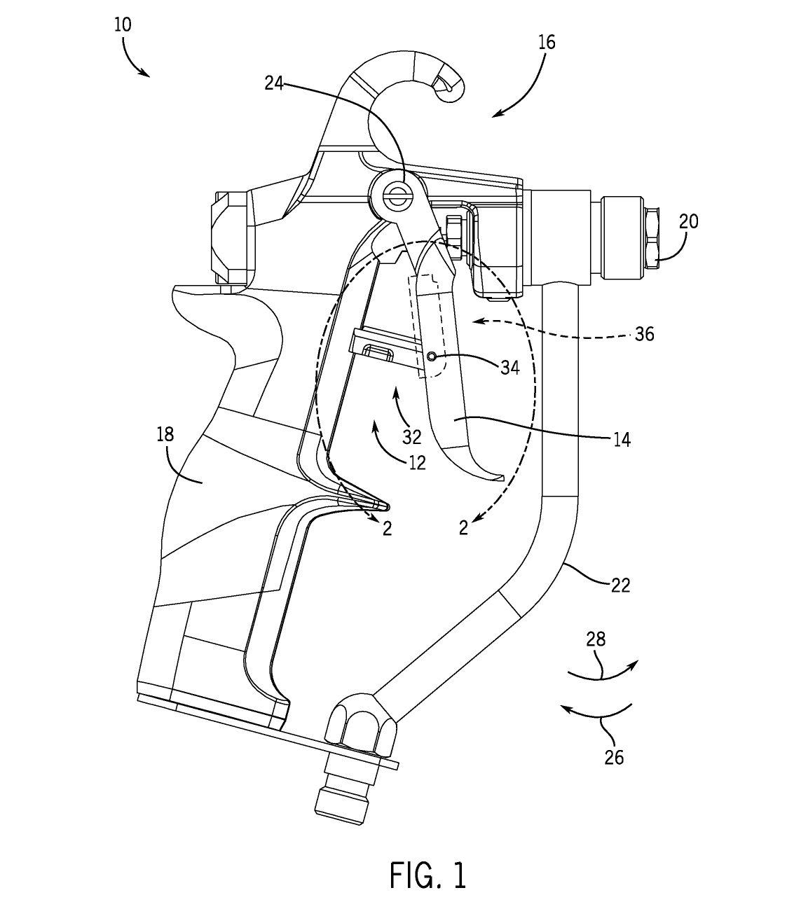

FIG. 1 is a side view of a spray tool system 10 with a trigger lock 12 that enables a user to selectively block movement of the trigger 14, and thus spraying by the spray tool system 10. As illustrated, the spray tool system 10 includes a body 16 that couples to the trigger 14, a handle 18, a spray orifice 20, and a coating material conduit 22. In operation, the handle 18 enables a user to hold and direct the spray tool system 10 and to spray a coating material (e.g., liquid, powder, etc.) by depressing the trigger 14. The trigger 14 couples to the body with the pin 24 (e.g., rotational joint), enabling the trigger 14 to rotate around the pin 24 in clockwise and counterclockwise directions 26 and 28. For example, during operation, the user may depress the trigger 14 to rotate the trigger 14 in a clockwise direction 26. As the trigger 14 rotates toward the handle 18, the trigger 14 opens a valve 30 within the body 16. When the valve 30 opens, a pressurized coating material (e.g., liquid or powder) is able to flow through the coating material conduit 22 and into the body 16, where the coating material discharges through the spray orifice 20. Similarly, after spraying the coating material, the user may release the trigger 14 to stop the flow of the pressurized coating material. Specifically, the release of the trigger 14 enables the trigger to rotate in a counter-clockwise direction 28 away from the handle 18. As the trigger 14 rotates away from the handle 18, the valve 30 closes blocking the flow of coating material. In FIG. 1, the trigger lock 12 is in a locked position 32 that blocks the trigger 14 from rotating in the clockwise direction 26, thus preventing the spray tool system 10 from spraying. In the illustrated embodiment, the trigger lock 12 couples to the trigger 14 with a pin 34 (e.g., rotational joint) enabling the trigger lock 12 to rotate between the locked position 32 (e.g., shown in solid lines) and an unlocked position 36 (e.g., shown in dashed lines). Accordingly, the trigger lock 12 may transition from the locked position 32 (e.g., extended position) to the unlocked position 36 (e.g., a retracted position or folded position) by rotating in clockwise direction 26, or transition from the unlocked position 36 to the locked position 32 by rotating in the counter-clockwise direction 28. The ability to transition the trigger lock 12 between the locked and unlocked position 32 and 36 enables the system 10 to selectively block unintentional depression of the trigger 14.

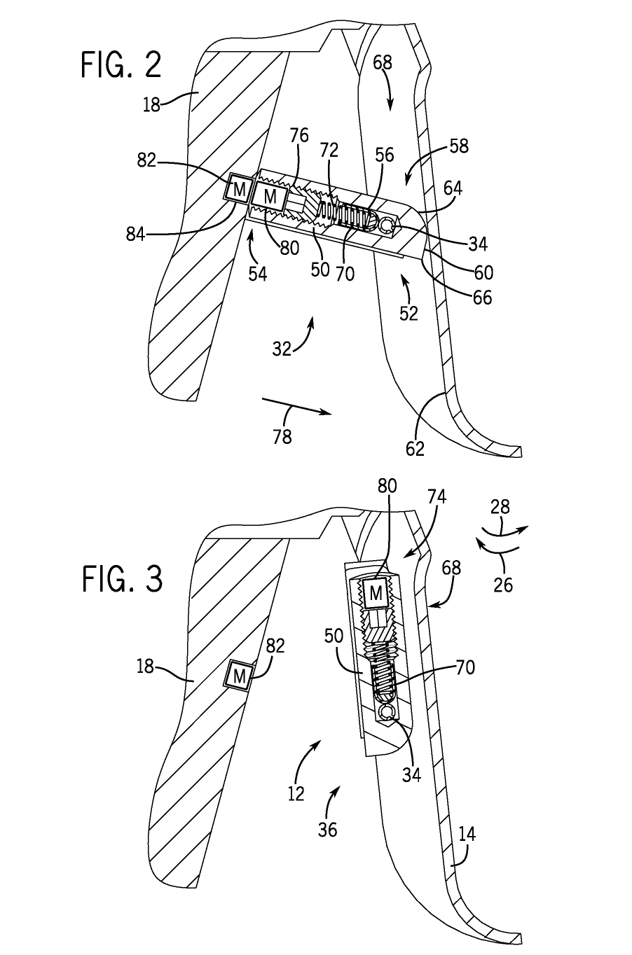

FIG. 2 is a partial cross-sectional side view of the spray system 10 of FIG. 1, taken within line 2-2, illustrating the trigger lock 12 in a locked position 32. As explained above, when the trigger lock 12 is in the locked position 32, the trigger lock 12 blocks the trigger 14 from rotating in the clockwise direction 26, which blocks the flow of coating material from the spray tool system 10. The trigger lock 12 includes a body 50 with a front portion 52, a rear portion 54, and an aperture 56. The body 50 couples to the trigger 14 with the pin 34 that passes through a pin aperture 58 in the front portion 52 of the body 50. As illustrated, the front portion 52 defines a front surface 60 in contact with a rear trigger surface 62. In the illustrated embodiment, the front surface 60 includes a rounded corner 64 (e.g., cam portion) that facilitates rotation of the trigger lock 12 in a clockwise direction 26 and a straight angled corner 66 (e.g., stop portion) that blocks rotation in the counter-clockwise direction 28. Accordingly, the present embodiment illustrates a trigger lock 12 that may only be unlocked in the counter-clockwise direction 28. However, in other embodiments, the front surface 60 may include only rounded corners 64 and 66 (e.g., 2 cam portions) that enable unlocking of the trigger lock 12 in clockwise and counter-clockwise directions 26 and 28. In still other embodiments, the trigger lock 12 may be spaced away from the rear trigger surface 62, so that the front surface 60 does not contact the rear trigger surface 62.

As illustrated, the rear aperture 56 extends through the rear portion 54. The rear aperture 56 enables the body 50 to receive a position-holding device or position holding device that frictionally engages the pin 34, to resist transitioning the trigger lock 12 between unlocked and locked positions. The position-holding device includes a spring holder 70, spring 72, and setscrew 76. As illustrated, the spring holder 70 rests within the aperture 56 and receives the spring 72. When assembled, the setscrew 76 threads into the body 50 to retain and compress the spring 72 in the spring holder 70. The compression of spring 72 forces the spring 72 in direction 78 and drives the spring holder 70 into frictional engagement with the pin 34. The friction between the spring holder 70 and the pin 34 resists movement of the trigger lock 12, thus resisting unintentional movement of the trigger lock 12.

In addition to the position-holding device, some embodiments may include a magnet 80 to resist transitioning the trigger lock 12 from a locked position 32 to an unlocked position 36. As illustrated, the magnet 80 (e.g., magnetized material) inserts into the aperture 56 behind the setscrew 76, proximate the rear portion 54 of the body 50. In the locked position 32, the magnet 80 aligns with and attracts the magnet 82 (e.g., magnetized material) resting in the aperture 84 of the handle 18. The magnetic attraction between the magnet 80 and the 82 forms a connection that resists movement of the trigger lock 12 out of the locked position 32. However, other embodiments may have different configurations. For example, in some embodiments, the trigger lock 12 may not include a magnet 80, but a magnetic or magnetizable material attracted to the magnet 82 in the handle. In other embodiments, the trigger lock 12 may not include a magnet 80 or a separate magnetizable material. Instead, the body 50 of the trigger lock 12 may be made out of a magnetizable material attracted to the magnet 82 in the handle 18, or vice versa, a magnetizable material may be placed in the aperture 84 that attracts the magnet 80 in the trigger lock 12. In still another embodiment, the handle 18 may be formed from a magnetizable material that attracts the magnet 80.

FIG. 3 is a partial cross-sectional side view of the spray system 10 of FIG. 1, taken within line 2-2, illustrating the trigger lock 12 in an unlocked position 36. In order to transition the trigger lock 12 from the locked position 32 to the unlocked position 36, a user provides a force in the clockwise direction 26 capable of overcoming the forces that resist movement in the clockwise direction 26. Specifically, when the force from the user in the clockwise direction 26 overcomes the magnetic connection between the magnets 80 and 82 and overcomes the friction force between the spring holder 70 and the pin 34, the trigger lock 12 transitions into the unlocked position 36. As illustrated, in the unlocked position the trigger lock 12 rests within a recess 74 of the trigger 14 enabling the user to depress the trigger 14 to spray a coating material with the spray tool system 10. Furthermore, in some embodiments, the recess 74 may include a magnet that attracts the magnet 80 to resist transitioning the trigger lock 12 out of the unlocked position 36.

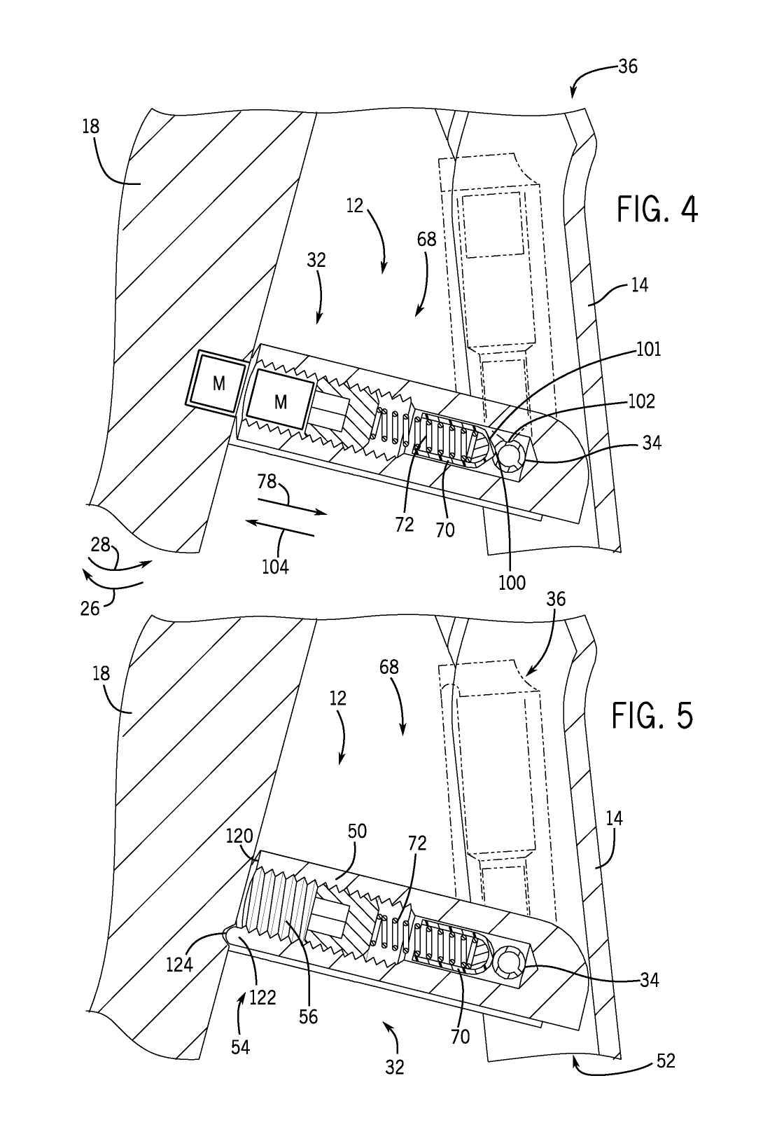

FIG. 4 is a partial cross-sectional side view of the spray system 10 of FIG. 1, taken within line 2-2, illustrating the trigger lock 12. In the illustrated embodiment, the pin 34 includes a first recess 100 and a second recess 102 at circumferentially offset positions, such that a tip 101 of the spring holder 70 selectively snaps into the recesses 100 and 102. The engagement of tip 101 within recesses 100 and 102 may further resist the movement of trigger lock 12 between the locked and unlocked positions 32 and 36. As illustrated, the engagement of tip 101 with first recess 100 resists movement of the trigger lock 12 out of the locked position 32. However, with enough rotational force, the spring holder 70 will compress the spring 72 in direction 104 enabling the tip 101 of spring holder 70 to exit the first recess 100. As the user continues to rotate the trigger lock 12 in direction 26, the trigger lock 12 transitions to the unlocked position 36. When the trigger lock 12 reaches the unlocked position 36, the spring 72 extends and moves the tip 101 of spring holder 70 into the recess 102. Accordingly, when the tip 101 of spring holder 70 extends into the recess 102, the engagement of tip 101 within recess 102 is able to resist movement of the trigger lock 12 out of the unlocked position 36. While the present embodiment illustrates a first and second recess 100 and 102, other embodiments may include only one recess. For example, one embodiment may only include the recess 100 for engagement with the tip 101 to resist movement of the trigger lock 12 out of the locked position 32. In another embodiment, there may only be the recess 102 for engagement with the tip 101 to keep the trigger lock 12 in the unlocked position 36.

FIG. 5 is a partial cross-sectional side view of the spray system 10 of FIG. 1, taken within line 2-2, illustrating the trigger lock 12. As illustrated, the rear portion 54 of the body 50 includes a rear surface 120. In the present embodiment, the rear surface 120 forms a protrusion 122 that corresponds to a recess 124 in the handle 18. In the locked position 32, the protrusion 122 rests within the recess 124, and resists rotational movement of the trigger lock 12 out of the locked position 32. However, with enough rotational force on the trigger lock 12, the protrusion 122 will exit the recess 124. As the trigger lock 12 continues to rotate in the clockwise direction 26, the trigger lock 12 transitions to the unlocked position 136. Moreover, other embodiments may include additional protrusions 122 and recesses 124 (e.g., 1, 2, 3, 3, 4, 5) to provide multiple holding positions. For example, the rear surface 120 may include protrusions 122 on opposite sides of the aperture 56 that correspond to recesses 124 in the handle 18. In another embodiment, the trigger lock 12 and the handle 18 may include the magnets 80 and 82 in addition to the protrusion 122 and the recess 124 to increasingly resist movement of the trigger lock 12 from the locked position 32 to the unlocked position 36.

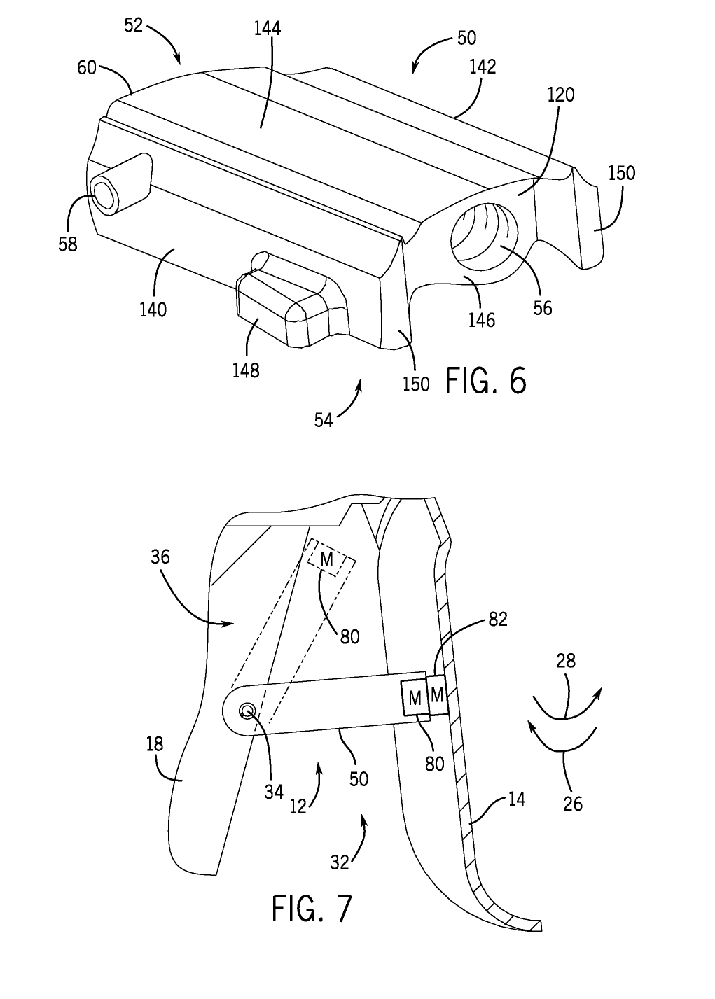

FIG. 6 is a perspective view of a trigger lock 12. As explained above, the trigger lock 12 includes the body 50 with the front portion 52, the rear portion 54, and the aperture 56. The body 50 enables the trigger lock 12 to couple to the trigger 14 with the pin 34 and enables the position-holding device to frictionally engage the pin 34. More specifically, the front portion 52 includes the aperture 58 that enables the trigger lock 12 to couple to the trigger 14 with the pin 34, while the rear portion 54 enables the position-holding device to contact pin 34 through the aperture 56. As explained above, the position-holding device frictionally engages the pin 34 to resist transitioning the trigger lock 12 between locked and unlocked positions 32 and 36.

As illustrated, the body 50 defines multiple surfaces including the front surface 60; the rear surface 120; side surfaces 140 and 142; top surface 144; and bottom surface 146. These surfaces facilitate alignment, movement, and coupling of the trigger lock 12 to the spray tool system 10. For example, the side surfaces 140 and 142 may include a respective flange 148 (e.g., finger grip or lever) that enable a user to contact and manipulate the trigger lock 12 between locked and unlocked positions 32 and 36. Moreover, the top and bottom surfaces 144 and 146 may form various shapes (e.g., concave, pseudo-concave, etc.) that may also assist the user in manipulating the trigger lock 12. In some embodiments, the rear surface 120 may include protrusions 150 that overlap opposite sides of the handle 18. The rear protrusions 150 may assist in aligning the trigger lock 12, and reduce axial stress on the pin 34. For example, when the trigger lock 12 is in the locked position 32, an axial force on the trigger lock 12 may force the protrusions 150 into contact with the handle 18, thus reducing the axial force on the pin 34.

FIG. 7 is a partial cross-sectional side view of the spray system 10 of FIG. 1, taken within line 2-2, illustrating the trigger lock 12. In the present embodiment, the trigger lock 12 couples to the handle 18 with the pin 34 instead of coupling to the trigger 14. Accordingly, the trigger 14 may include the magnet 82 or another type of mechanism (e.g., protrusion or recess) that resists movement of the trigger lock 12 between locked and unlocked positions 32 and 36. In operation, the trigger lock 12 rotates between locked and unlocked positions 32 and 36 by rotating in the counter-clockwise direction 26 towards the handle 18. In other embodiments, the trigger lock 12 may transition into an unlocked position 36 by rotating in the clockwise direction 26 towards the handle 18. As explained above, the trigger lock 12 enables the user to selectively block unintentional depression of the trigger 14.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a sprayer comprising:
a handle;
a trigger configured to move between a first trigger position and a second trigger position, wherein the sprayer is configured to block flow of a coating material when the trigger is in the first trigger position and to spray the coating material when the trigger is in the second trigger position;
a trigger lock coupled to the trigger, wherein the trigger lock is configured to selectively block movement of the trigger between the first trigger position and the second trigger position.

2. The system of claim 1, wherein the trigger lock is configured to rotate between a locked position and an unlocked position.

3. The system of claim 2, wherein the trigger lock comprises a first magnet.

4. The system of claim 3, wherein the trigger lock comprises a second magnet in the handle separate from the first magnet, wherein the second magnet is configured to attract the first magnet in the trigger lock and to retain the trigger lock in the locked position.

5. The system of claim 2, wherein the trigger lock rotates about a pin coupled to the handle.

6. The system of claim 5, wherein the trigger lock comprises a spring and a spring cover, and wherein the spring is configured to create a frictional engagement between the spring cover and the pin.

7. The system of claim 6, wherein the pin comprises one or more recesses configured to engage a tip of the spring cover.

8. The system of claim 6, wherein the pin comprises a first recess that engages the tip of the spring cover when the trigger lock is in the locked position and a second recess that engages the tip of the spring cover when the trigger lock is in the unlocked position.

9. The system of claim 1, wherein the handle comprises a recess and the trigger lock comprises a protrusion, wherein the recess is configured to engage the protrusion on the trigger lock and to retain the trigger lock in the locked position.

10. The system of claim 1, wherein the trigger lock includes flanges that extend from first and second sides of the trigger lock.

11. A system, comprising:
a magnetic trigger lock configured to block movement of a trigger of a sprayer between a first trigger position and a second trigger position, wherein the first trigger position does not actuate a mechanism coupled to the trigger, and the second trigger position does actuate the mechanism.

12. The system of claim 11, comprising a sprayer having a handle, the trigger, the mechanism, and the magnetic trigger lock.

13. The system of claim 11, wherein the mechanism comprises a valve.

14. The system of claim 11, comprising the trigger, wherein the magnetic trigger lock is coupled to the trigger.

15. The system of claim 11, wherein the magnetic trigger lock comprises finger grips that extend from first and second sides of the magnetic trigger lock.

16. A system, comprising:
a valve of a sprayer;
a trigger coupled to the valve, wherein the trigger is configured to move between a first trigger position and a second trigger position, the valve is closed when the trigger is in the first trigger position, and the valve is open when the trigger is in the second trigger position;
a magnetic trigger lock coupled to the trigger, wherein the magnetic trigger lock is configured to block movement of the trigger between the first trigger position and the second trigger position.

17. The system of claim 16, wherein the magnetic trigger lock comprises a spring and a spring cover, and the spring is configured to create a frictional engagement between the spring cover and a pin.

18. The system of claim 16, wherein the magnetic trigger lock comprises a magnet made of a magnetized material, wherein the magnet is configured to resist movement of the trigger via a magnetic force.

19. The system of claim 18, comprising the sprayer having the valve, the trigger, and the magnetic trigger lock.

20. The system of claim 16, wherein the magnetic trigger lock is configured to rotate between a recessed position in the trigger and an extended position that projects out of the trigger.
